(19) United States
(12) Patent Application Publication
(10) Pub. No.: US 2010/0001960 A1
(43) Pub. Date: Jan. 7, 2010

(54) SYSTEMS AND METHODS FOR GESTURAL INTERACTION WITH USER INTERFACE OBJECTS

(75) Inventor: George Edward WILLIAMS, Oakland, CA (US)

Correspondence Address: INGRASSIA FISHER & LORENZ, P.C. (EchoStar), 7010 E. COCHISE ROAD, SCOTTSDALE, AZ, 85253, US

(73) Assignee: SLING MEDIA, INC., San Mateo, CA (US)

(21) Appl. No.: 12/167,041

(22) Filed: Jul. 2, 2008

(51) Int. Cl. G06F 3/041

(52) U.S. Cl. 345/173

(57) ABSTRACT

Systems and methods produce imagery on a display in response inputs received from a directional input device, wherein the inputs correspond to directional instructions provided by a user. A first input corresponding to a first directional instruction in a first direction is received from the directional input device, and an object is identified based upon the first input. A second input corresponding to a second directional instruction from the user in a second direction different from the first direction is identified from the directional input device, and a function associated with the identified object is invoked in response to the second input.

### TECHNICAL FIELD

The present invention generally relates to user interfaces, and more particularly relates to systems and methods for invoking functions associated with identified objects in response to directional inputs.

### BACKGROUND

Portable computing devices such as portable computers, smart phones, personal digital assistants (PDAs), media players and the like have become extraordinarily popular in recent years. With increasing data processing capabilities of such devices and the widespread availability of wireless networks, many consumers are now using portable devices to view streaming video or other media content that is stored on the device or that is received over a wireless data connection.

A challenge that continually arises, however, relates to designing efficient yet intuitive user interfaces, particularly for relatively small portable devices. More particularly, it can be a challenge to efficiently provide the various features desired by the user given the constraints of limited display space and limited input availability. It is therefore desirable to create systems and methods for efficiently interacting with user interface objects presented on a display.

These and other desirable features and characteristics will become apparent from the subsequent detailed description and the appended claims, taken in conjunction with the accompanying drawings and this background section.

### BRIEF SUMMARY

Various embodiments relate to systems and methods for producing imagery on a display in response inputs received from a directional input device, wherein the inputs correspond to directional instructions provided by a user. A first input corresponding to a first directional instruction in a first direction is received from the directional input device, and an object is identified based upon the first input. A second input corresponding to a second directional instruction from the user in a second direction different from the first direction is identified from the directional input device, and a function associated with the identified object is invoked in response to the second input. In various embodiments, the first input enables scrolling to the identified object, and the function associated with the identified object is a non-directional function such as opening a web site associated with the identified object, presenting information about the identified object, and/or the like.

In another embodiment, a device is configured to present a plurality of objects to a user. The device comprises a display configured to present the objects to the user, and a directional input device configured to provide input signals in response to directional inputs received from the user, wherein the directional inputs are received in a first direction and in a second direction different from the first dimension. The device also comprises a processor that is configured to receive the input signals from the directional input device and to provide video signals to the display to generate the imagery, wherein the controller is further configured to identify one of the plurality of objects in response to directional inputs received in the first direction and to invoke a function related to the identified object in response to directional inputs received in the second direction.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram showing various components of an exemplary video placeshifting system;

FIG. 2 is a block diagram of an exemplary computing device;

FIG. 3 is a conceptual logic diagram for an exemplary carousel structure; and

FIG. 4 is a flowchart of an exemplary method for processing inputs received from a directional input device.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various embodiments, a directional input from a user invokes a function associated with an icon or other object presented on the display. In contrast to conventional systems that limit directional inputs to directional features such as scrolling or interface navigation, the function invoked in various embodiments may be a non-directional function, such as opening a web page associated with the object, presenting additional data relating to the object, executing a macro, or the like.

As an example, a media player application may present one or more icons relating to television channels. Directional movements in one dimension (e.g., horizontal) may scroll through an array or other list of icons until a desired channel icon is identified. Pressing/selecting the icon may have the typical result of tuning the channel for display to the user. Additionally, however, directional movements (e.g, upward or downward inputs applied to the directional input device) can provide other functions or features associated with the object. In this example, the identified object remains fixed in place on the display while the directional input is applied; the directional input is not used for navigation or scrolling, but rather to invoke a non-directional function associated with the object. Examples of non-directional functions could include opening an electronic program guide associated with the channel, directing a video recorder to record content on the identified channel, and/or opening a web site to present marketing information, video clips and/or the like that may be associated with the identified channel. Other embodiments could be formulated to take any other actions, and/or actions associated with various objects could be configurable by the user or application as desired.

For convenience, the concepts herein are generally described with respect to a “place shifting” media player system that incorporates a smart phone or similar portable computing device. The invention, however, is not limited by this exemplary implementation. Indeed, the concepts described herein may be readily applied in any personal or portable computing environment that includes a directional input device and a graphical user interface presented on any sort of display. Similarly, the concepts are not limited to media player applications, and may readily adapted for use with any type of application, applet, program or the like. Various additional examples are presented below.

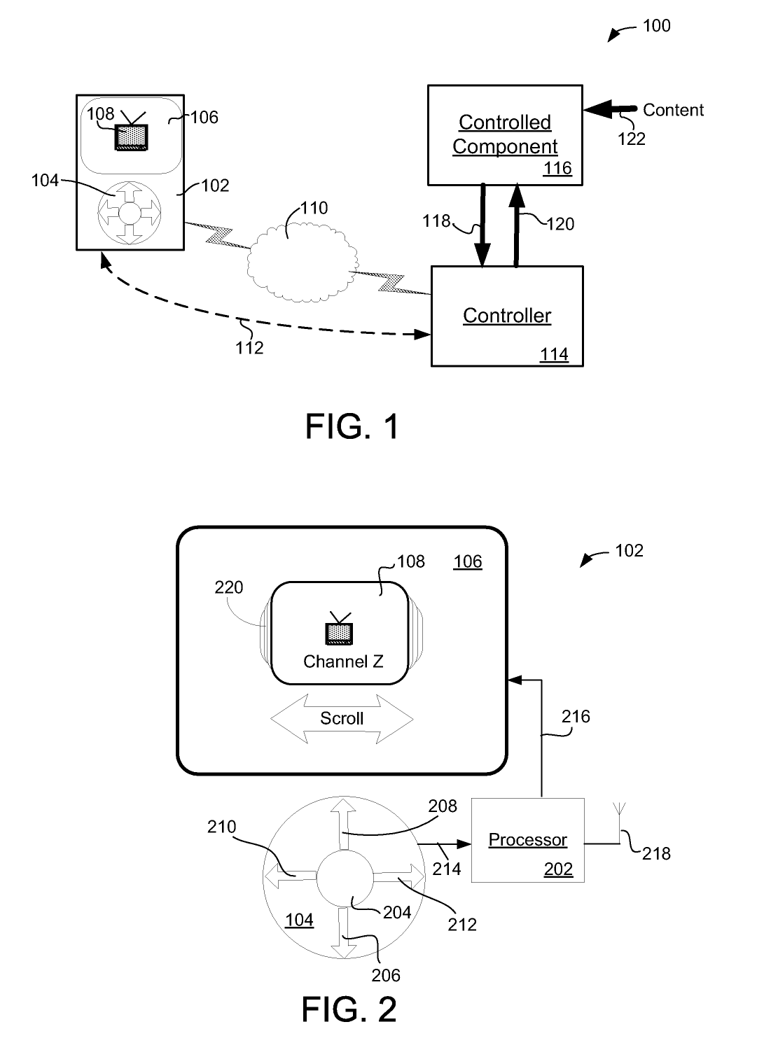

Turning now to the drawing figures and with initial reference to FIG. 1, a portable device 102 is shown in conjunction with an exemplary “place shifting” system 100. This system 100 includes a remotely-located controller device 114 that interacts with a remotely-located controlled component 116 to obtain video programming 122. In this example, portable device 102 interacts with controller 114 via a connection 112 through a wireless or other network 110 to obtain streaming content that can be presented on display 106. The particular content received and displayed is controlled by a user interface executing on portable device 102. To that end, portable device 102 displays icons or other objects 108 on display 106, and receives directional inputs from the user via a directional input device 104.

Portable device 102 is any device or application capable of interacting with user inputs to provide a desired user experience. In various embodiments, media player 102 is any sort of mobile phone, personal digital assistant (PDA), media player, personal computer and/or the like. As shown in FIG. 2, portable device 102 includes a display 106 for presenting imagery to the user, and a directional input device 104 for receiving directional inputs from the user. Although not expressly shown in FIG. 1, device 102 typically includes a microprocessor or other control circuitry, as well as associated memory, input/output and the like. Additional input devices (e.g., keypads, buttons and/or the like) may also be present for additional functionality and convenience.

In many embodiments, device 102 includes a radio frequency (RF) transceiver that is able to interact with network 110 to provide a data connection 112 to controller 114. Network 110 may include any sort of links to telephone networks, IEEE 802.11 (“Wi-Fi”) or similar wireless networks, the Internet and/or any other public or private networks that may interconnect portable device 102 and controller 114. In an exemplary embodiment, network 110 encompasses a wireless telephone connection from portable device 102 as well as an Internet connection to controller 114, although other embodiments may use any other data connection(s) to provide communications to and from portable device 102.

Controlled component 116 is any device, circuitry or other logic capable of receiving video content 122 and providing a suitable video output 118. In various embodiments, controlled component 116 includes a conventional digital video recorder (DVR) that is able to receive video content 122 and to record programs for subsequent playback to output 118. In other embodiments, controlled component 116 is any sort of set top box or other receiver associated with a satellite or cable television service. In still other embodiments, a television, cable and/or satellite receiver may be combined with a DVR feature for receiving, decoding and recording of video content 122. Controlled component 116 may alternately be implemented with a digital versatile disk (DVD) player or other device that receives content 122 via a physical media.

Controller 114 is any device, circuitry or other logic capable of providing content 122 received from a controlled device 116 to a portable device 102 via network 110. In various embodiments, controller 114 is a standalone “place shifting” device such as any of the various products available from Sling Media of Foster City, Calif. Such products are able to receive video output 118 from the controlled component 116 and to convert the received signals into a packetized or other format that can be conveniently routed across network 110 to one or more portable devices 102. In many embodiments, controller 114 provides a control signal 120 to the controlled component 116 to obtain desired outputs 118. For example, controller 114 may provide signals 120 that emulate signals produced by a remote control associated with controlled component 116 and that are received via an infrared sensor on controlled component 116. Such instructions may, for example, direct controlled component 116 to tune to a particular channel of received content 122, to record a particular channel on a DVR or the like, to display an electronic program guide, or to produce any other output 118 that may be desired by the user.

In some embodiments, controller 114 and controlled component 116 are physically combined into a common chassis or housing. Such a device may be perceived from a user perspective as a single device that receives content 122 from a cable, satellite, broadcast or other source and that delivers packetized or other content to network 110, as appropriate. In such embodiments, signals 118 and 120 may not be physically identifiable from the outside of the housing, but may instead represent data signals passed between internal circuits, programming modules or other components of the hybrid system.

System 100 allows a user to view video content 122 on a portable device 102 that is remotely located from controller 114, but that communicates with controller 114 via network 110. To that end, the user interacts with an interface on portable device 102 to select programming and to take other actions as desired. In various embodiments, portable device 102 presents various icons or other objects 108 to the user via display 106, and receives inputs from the user via a directional input device 104. As noted above, directional inputs from directional input device 104 may be processed in any manner to provide navigation of the user interface, and also to invoke non-directional functions associated with one or more objects 108, as desired.

Objects 108 may be any sort of interface features capable of representing any sort of data or information. In various embodiments, objects 108 are conventional icons representing various items that can be selected by the user or otherwise activated to perform additional tasks. Objects 108 may represent television channels provided with content 122, for example; in other embodiments, objects 108 may represent television programs stored on controlled component 116, control buttons for a DVR or other controlled component 116, or any other items. Users interact with objects 108 in any manner. As described more fully below, various embodiments allow users to provide directional inputs using input device 104 that result in non-directional functions being executed.

With reference now to FIG. 2, directional input device 104 may be any sort of multi-dimensional input device such as a touchpad, touch screen, joystick, directional pad, trackball, mouse and/or the like. Such a device 104 may provide any number of input signals 214 to a processor 202 or the like for subsequent processing. Such input signals 214 may include signals corresponding to movement in any direction (e.g., directions 206, 208, 210, 212 in FIG. 2). Input device 104 may also include a “select” button 204 or similar feature that allows for selection of objects 108, as appropriate.

In various embodiments, the user moves or otherwise actuates input device 104 to produce movement in two or more dimensions. Such movement in a first direction (or dimension) may be correlated to scrolling, navigation and/or other directional effects presented on display 104. Additionally, directional inputs in other directions or dimensions may be used to invoke non-navigational functions. Depending on the type of directional input device 104 that is provided, the user may provide directional inputs in the form of gestures (e.g., movement of a finger or stylus with respect to a touchpad or touch screen), or gestures can be implied from movement of a directional pad, trackball, joystick or the like. Direct or implied gestures may be identified from any sort of conventional gesture recognition or other input detection techniques within device 102.

In the embodiment shown in FIG. 2, a series of icons 108 are shown as part of a carousel-type data structure 220. As the user provides directional inputs to device 104 in a first direction/dimension (e.g., the horizontal direction as depicted in FIG. 2), icons 108 scroll in the direction of the movement until a desired icon 108 is identified (e.g., by being located at a central or other focused position, by being highlighted, or by any other technique). Directional inputs in another direction (e.g., the vertical direction as depicted in FIG. 2) can then be used to activate other features associated with the object 108. Equivalent embodiments may be spatially arranged in any other manner (e.g., with scrolling in a vertical direction and functions invoked in response to horizontal movements), and/or may provide additional or alternate features as desired.

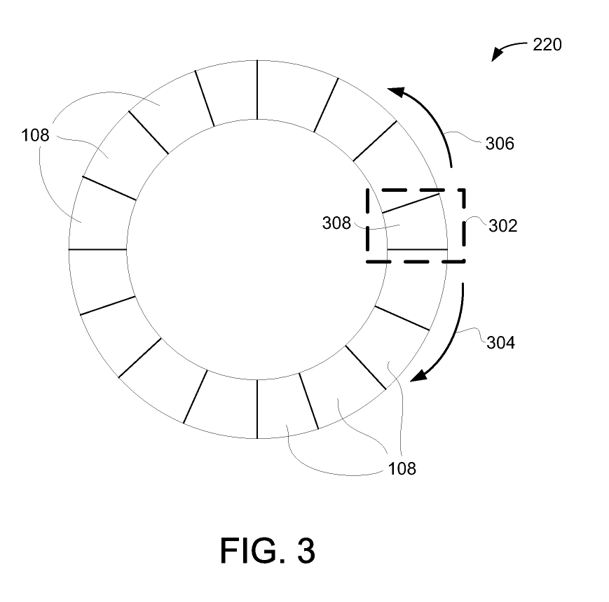

With momentary reference to FIG. 3, an exemplary carousel data structure 220 can be logically arranged as a one-dimensional array of objects 108, with a pointer or other indicator 302 providing a logical marker for the indicated object 308. In various embodiments, objects 108 in structure 220 may be scrolled or otherwise traversed in response to directional inputs applied to input device 104. An input in a first direction (e.g., “up” or “left”) could be mapped to movement in direction 304, for example, whereas movement in an opposing direction (e.g., “down” or “right”) could be mapped to movement in direction 306, as desired. The various objects 108 may be linked to each other in any manner, such as using any sort of linked list or other array structure as appropriate. The exemplary structure 220 in FIG. 3 shows a “circular” structure that has no obvious beginning or end, similar to a carousel on a conventional slide projector. In such embodiments, continued movement in either direction 304 or 306 will eventually return to the originally-indicated object 308, after scrolling through all of the objects 108 in structure 220. Equivalent embodiments may be fashioned in a more linear fashion with an express beginning and end to the array.

Returning to focus on FIG. 2, traversing structure 220 may be graphically presented to the user on display 104 in any manner. In various embodiments, objects 108 may be presented in an horizontal, vertical or other “bar” that moves with respect to a “hot spot” or other pointer 302 (such as the center or any other focused location on display 106) that is used to select identified objects 308. Other embodiments may provide a first portion of display 106 that shows the arrangement of objects 308, with another portion of display 106 presenting additional information about the identified object 308. In still other embodiments, a single object 108 may be displayed at any time, with movement from one portion of display 104 to another indicating traversal of structure 220. Multiple carousel structures 220 may be presented in various embodiments; selecting a particular object 308 may result in an additional “sub-carousel” being presented in various embodiments. Alternate embodiments may implement carousel or other listing structures 220 in very different ways, or may omit such structures entirely.

In many embodiments, object 108 remains relatively stationary on display 106 while directional inputs in the non-scrolling direction are entered. That is, movement of object 108 within carousel structure 220 may be effectively limited to a single dimension (e.g., the horizontal directions 210 and 212 of FIG. 2). Movements in other directions (e.g., the vertical directions 206 and/or 208 in FIG. 2) can therefore be used to invoke non-directional functions. Such a function may be any directed by any sort of programming or scripting, and may take any action whatsoever. As a result, a single icon or other object 108 can be used to represent multiple different actions that can be carried out by a program.

The particular actions that are carried out in response to various directional inputs vary widely. In some embodiments, the functions executed by directional inputs may be configured by the user. Examples of functions that may be executed include opening another application, applet or other code module; opening a web page or the like; executing a script or macro that includes one or more instructions to execute; or the like. In embodiments wherein objects 108 represent television channels, for example, movement in a first dimension (e.g, horizontal dimension represented by directions 210 and 212 in FIG. 2) might result in scrolling or other traversal of structure 220. An object 108 may be selected by simply scrolling until the identified object 308 is in the “hot spot” or other location; alternately, the object 108 may be selected in response to a press of button 204 or the like. In such embodiments, an upward movement 208 (or downward movement 206) applied to an indicated object 308 may result in a different function being invoked. A number of exemplary embodiments that include various types of non-directional functions are described more fully below.

As noted above, device 102 typically includes any sort of microprocessor, microcontroller or other data processor 202 that is capable of receiving input signals 214 from input device 104 and of providing suitable signals 216 to generate desired imagery on display 106. In various embodiments, processor 202 is provided with associated memory for storage of data and instructions, and with any other appropriate input/output features. In the embodiment shown in FIG. 2, processor 202 communicates with a wireless transceiver 218 that is able to send and receive data on network 110, as described more fully above.

Processor 202 suitably executes conventional computer-executable instructions stored in memory or mass storage to implement many of the various features described herein. These software or firmware instructions may be stored in volatile and/or non-volatile memory within device 102, and/or may be temporarily stored in any sort of mass storage or other magnetic, optical or other media. Further, the instructions may be provided in any compiled, interpreted or other format in any programming or scripting language, and in any source or object code format.

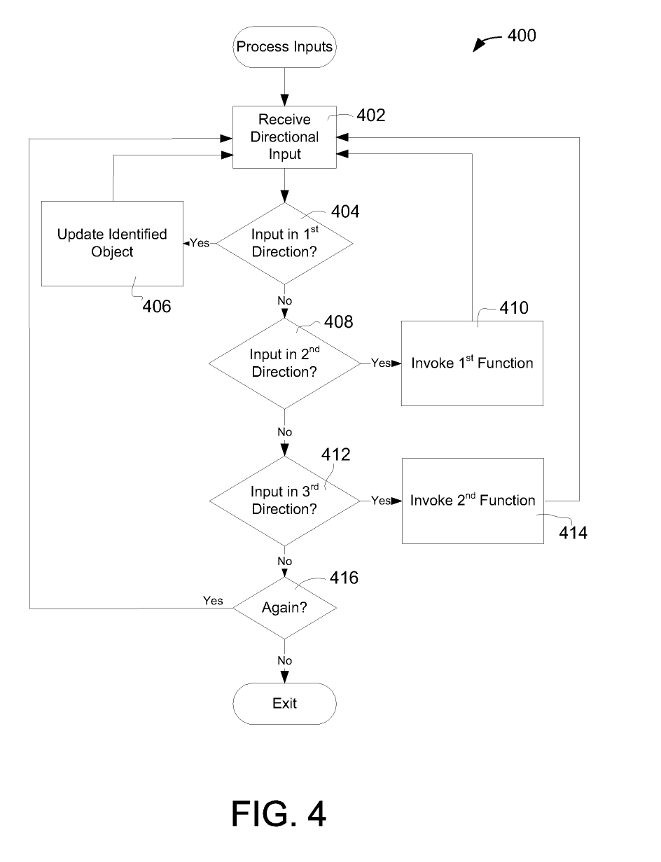

FIG. 4 is a flowchart of an exemplary data processing method 400 that may be executed by process 202 in various embodiments. The particular routines shown in FIG. 4 are intended to represent logical steps that may be taken within various implementations; other embodiments may provide additional steps, may execute the steps shown in any other temporal order, and/or may differently organize the various steps of method 400 in any manner.

Method 400 suitably includes the broad steps of receiving input signals corresponding to directional inputs from the user (step 402), identifying an object 108 (step 406) in response to a directional input provided in a first direction (step 402), and invoking a function (steps 410 and/or 414) in response to a directional input provided in another direction different from the first direction (steps 408 and/or 412). Process 400 may be repeated (step 416) as desired, or otherwise operated on any temporal basis to process the various inputs provided by the user.

Directional inputs are received in any manner (step 402). In various embodiments, signals 214 (FIG. 2) may be processed in any manner to identify the user's intent. For example, movement in any number of directions (e.g., directions 206, 208, 210, 212 in FIG. 2) may be indicated by the input signals 214 themselves. In other embodiments (e.g., those using touch pads or touch screens), input device 104 may provide absolute or relative motion coordinates (e.g., X,Y or ΔX,ΔY coordinate pairs) that can be subsequently processed to determine directional inputs provided by the user in the form of gestures or other movements. Gestures may be recognized through any sort of game programming, collision codes, and/or other techniques. In other embodiments, portions of an icon or other object 108 presented on display 106 may be mapped to multiple spatial regions to identify movements from one region to another. Directional movements may therefore be recognized in any manner depending upon the particular directional input device 104, display 106 and other factors as appropriate.

As noted above, movement in a first direction may be identified (step 404) and used to scroll or otherwise select a particular object 108. Although step 404 refers to tracking movement in a first direction, many embodiments may actually track movement in a first dimension (e.g., a vertical or horizontal dimension), with positive and negative movement in that dimension (e.g., left/right, or up/down) corresponding to scrolling or other traversal of objects 108 in two different directions. The various directions sensed in steps 404, 408 and/or 412 may be logically arranged with respect to each other in any manner. In various embodiments, the directions may be more or less orthogonal to each other, as in the case of vertical and horizontal inputs as described above.

Objects 108 may be identified (step 406) in any manner. Various embodiments may use the carousel-type structure described above, for example, although other embodiments may simply provide scrolling or other navigation using any conventional techniques.

The exemplary embodiment of FIG. 4 shows the ability to invoke two different functions (steps 410 and 414) in response to movement in a 2^{nd} or 3^{rd} direction (steps 408 and 412, respectively). In practice, only one function may be provided; inputs corresponding to other directions may result in conventional navigation (including scrolling), for example, or any other default action (including no action) as desired.

Functions 410 and 414 may be implemented in any manner. As noted above, such functions may implement features unrelated to direction or navigation, such as executing a script, routine, program or other code associated with the identified object 308. Further, in some embodiments, the particular function executed may be customized by the user, or by an application programmer, administrator or the like.

A number of examples for use in a placeshifting/media player embodiment will now be presented with reference again to FIG. 1. In one exemplary embodiment, a user is provided with a sequence of objects 108 in a carousel-type or other structure 220 as described above. In this embodiment, movement in a first (e.g., horizontal) direction results in scrolling or other navigational features; movement in a different direction (e.g, up and/or down) results in a function being invoked. Examples of such functions might include, without limitation, opening an electronic program guide (EPG); starting a recording session with a DVR or other device; opening a web page; and/or executing another macro or other scripting feature.

When a particular channel is indicated, for example, an “up” gesture (or any other gesture orthogonal to the direction of scrolling) could be used to open a view of the EPG that displays program listings for the indicated channel. An EPG may be activated by, for example, transmitting a message from portable device 102 across connection 112 to controller 114. The message may include parameters or other instructions to allow the EPG to be further tuned to a particular channel (e.g., a channel represented by indicated object 308). Controller 114 suitably receives the message and provides instructions 120 to controlled component 116 to create the appropriate display with video signals 118. Video signals 118 are then packetized or otherwise processed to deliver the desired imagery to device 102 for presentation to the user on display 106.

A recording session may be similarly initiated using messages transmitted from portable device 102 to controller 114 via connection 112. Using parameters contained in the message, controller 114 suitably instructs controlled component 116 to record a desired channel (e.g., the channel represented by indicated object 108) using signals 120, as appropriate. Further embodiments may include time parameters that instruct component 116 to record for a pre-determined period of time (e.g, one hour), or the user may be prompted to enter time and/or other parameters as appropriate.

Still other embodiments could initiate a web browser session to a uniform resource locator (URL) or other address. For example, a gesture received with respect to an indicated icon could open a browser, chat, SMS or other connection to any online content associated with the indicated object. The particular URL/address or other indicator of the online content may be determined in any manner. In various embodiments, the user may be connected to a web site that presents video clips of programs recorded from an indicated television channel. In another embodiment, the web site may provide marketing or informational materials associated with the indicated object (e.g., information about upcoming programs, subscription fees, or the like). In still other embodiments, the user could be connected to an online community of any sort that is related to the streaming content, channel, or the like. For example, the gesture could open access to a website or community associated with fans of a particular program being viewed. In such embodiments, audio from the streamed content may continue to play while the user is viewing the online content, although is not necessary in all embodiments. The user may be further allowed to switch between online and streamed content in any convenient manner.

In still other embodiments, the directional gesture could result in a listing of options for viewing information associated with the indicated object. Such information may be retrieved from a database, such as any online database accessible to the media player application. Such information may include information about a program, artist, actor/actress, producer/director, and/or the like that could be presented as part of the streamed content. The information may be static text and/or other imagery that is presented in a portion of the displayed view along with the streamed content, for example, or overlying the streamed content in any manner.

Many of the various functions invoked by directional commands may be implemented using scripts or macros that direct the execution of one or more actions. Such actions may be taken by the portable device 102, by controller 114, and/or by controlled component 116. For example, if the function is intended to initiate a recording session of a particular channel, controller will typically tune controlled component 116 to the particular channel using a first command 120, then instruct the controlled component 116 to begin recording with a second command 120. At the completion of the recording time, controller 114 will typically send a subsequent command 120 to direct the controlled component 116 to stop recording. Scripts/macros could alternately perform multiple actions on the portable device 102, such as loading a browser application and then subsequently directing the browser to load a particular URL/address. As noted above, the various functions carried out by various embodiments can be configured in any manner.

As noted at the outset, many other embodiments other than those associated with placeshifting or media playing could be formulated. As an example, a phone list in a mobile phone could be scrolled or otherwise traversed by directional movement in a first dimension or direction, with select inputs (e.g, from button 204) and movements in other directions invoking various functions with respect to the identified person or entity. A “select” input, for example, could be used to initiate a phone call to an identified person, while a directional keypress could initiate a text message or email to that person. The concepts of associating various functions with a single object and invoking a non-directional function in response to a directional input can thusly be applied in any sort of application or environment.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method of processing a plurality of inputs received from a directional input device, wherein each of the plurality of inputs corresponds to a directional instruction provided by a user, the method comprising:
receiving a first one of the plurality of inputs from the directional input device, wherein the first input corresponds to a first directional instruction in a first direction;
identifying an object based upon the first input;
receiving a second one of the plurality of inputs from the directional input device, wherein the second input corresponds to a second directional instruction from the user in a second direction that is different from the first direction; and
in response to the second one of the plurality of inputs, invoking a function associated with the identified object.

2. The method of claim 1 wherein the function is a non-directional function.

3. The method of claim 1 wherein the object remains fixed in place on a display while the second input is received.

4. The method of claim 1 wherein the identifying comprises scrolling to the identified object in response to the first directional instruction and wherein the function is a non-directional function.

5. The method of claim 1 further comprising:
receiving a third one of the plurality of inputs from the directional input device, wherein the third input corresponds to a third directional instruction different from the first and second directional instructions; and
in response to the third one of the plurality of inputs, invoking a second function associated with the identified object, wherein the second function is different from the second function.

6. The method of claim 1 wherein the object is one of a plurality of objects arranged in a one-dimensional array, and wherein the identifying comprises selecting one of the plurality of objects by scrolling to the identified object in response to the first input.

7. The method of claim 1 wherein the object represents a television channel within a media player application.

8. The method of claim 7 wherein the function comprises opening an electronic program guide to a list of programming on the television channel.

9. The method of claim 7 wherein the function comprises initiating recording of the television channel.

10. The method of claim 7 wherein the function comprises opening a web page associated with the television channel.

11. The method of claim 7 further comprising receiving a select input distinct from the first and second inputs, and displaying the television channel in response to the select input.

12. The method of claim 1 wherein the function comprises a macro, wherein the macro is configured to initiate a plurality of instructions provided to a remotely-located controlled device.

13. The method of claim 12 wherein the plurality of instructions comprises a plurality of wireless commands provided to the remotely-located controlled device by a remotely-located controller.

14. A system for producing imagery on a display in response to a plurality of inputs received from a directional input device, wherein each of the plurality of inputs corresponds to a directional instruction provided by a user, the system comprising computer-executable instructions stored on a digital storage medium, wherein the computer-executable instructions comprise:
first logic configured to receive a first one of the plurality of inputs from the directional input device, wherein the first input corresponds to a first directional instruction in a first direction;
second logic configured to identify an object based upon the first input;
third logic configured to identify a second one of the plurality of inputs from the directional input device, wherein the second input corresponds to a second directional instruction from the user in a second direction that is different from the first direction; and
fourth logic configured to invoke a function associated with the identified object in response to the second one of the plurality of inputs.

15. A device configured to present a plurality of objects to a user, the device comprising:
a display configured to present the objects to the user;
a directional input device configured to provide input signals in response to directional inputs received from the user, wherein the directional inputs are received in a first direction and in a second direction different from the first dimension; and
a processor configured to receive the input signals from the directional input device and to provide video signals to the display to generate the imagery, wherein the controller is further configured to identify one of the plurality of objects in response to directional inputs received in the first direction and to invoke a function related to the identified object in response to directional inputs received in the second direction.

16. The device of claim 15 wherein the plurality of objects represents a plurality of television channels available within a media player application executing on the processor, and wherein the function is a non-directional function comprising one of: opening an electronic program guide to a list of programming on the identified television channel, initiating recording of the identified television channel, and opening a web page associated with the identified television channel.

17. The device of claim 16 wherein the controller is further configured to receive a select input distinct from the first and second inputs, and to present content from the identified television channel on the display in response to the select input.

18. The device of claim 15 wherein the function comprises a macro, wherein the macro is configured to initiate a plurality of instructions provided to a remotely-located controlled device.

19. The device of claim 15 wherein the plurality of objects comprises a plurality of icons arranged in a one-dimensional array, and wherein the processor is further configured to scroll through the one-dimensional array in response to the directional inputs received in the first direction.

20. The device of claim 15 wherein the first and second directions are substantially orthogonal to each other.
